(19) United States
(12) Patent Application Publication
(10) Pub. No.: US 2002/0176243 A1
(43) Pub. Date: Nov. 28, 2002

(54) Power saving illuminating device

(76) Inventor: Yifei Yao, Shantou City (CN)

Correspondence Address: SQUIRE, SANDERS & DEMPSEY L.L.P, 600 HANSEN WAY, PALO ALTO, CA, 94304-1043, US

(21) Appl. No.: 10/007,335

(22) Filed: Nov. 8, 2001

(30) Foreign Application Priority Data
May 28, 2001 (CN) 012246727

(51) Int. Cl. F21V 5/00; F21V 7/04

(52) U.S. Cl. 362/31; 362/186; 362/202; 362/311

(57) ABSTRACT

The present invention concerns a power saving illuminating device. The device comprises a base, at least one semiconductor luminotron, a DC power source disposed within the base, and a transparent refractive body covered on the opening of the base, said semiconductor luminotron being connected to said power source, wherein said transparent refractive body is full of light reflecting granulae within its body and is positioned in a manner that an end surface thereof is facing the semiconductor luminotron. The device is power saving and may be used as signposts, guideposts, colored lights, decoration lights and illuminating sign plates.

### PRIORITY REFERENCE TO PRIOR APPLICATION

This application claims benefit of Chinese patent application serial number 01224672.7, entitled “A POWER SAVING ILLUMINATING DEVICE,” filed on May 28, 2001, by inventor Yifei Yao.

The present invention relates to a power saving illuminating device, especially to a power saving illuminating device wherein semiconductor luminotrons such as LED are adopted as the electric light source.

Because of the power saving characteristics, semiconductor luminotrons are fequently used as the main electric lighting source of the dim lights, colored lights, decoration lights, illuminating data plates, etc. In some applications, they are arranged to form certain patterns to illuminate directly, while in other applications, the light from a semiconductor luminotron is first reflected to a transparent lampshade by a convex mirror and then scattered into the surroundings. In such applications, evenly distributed edges are formed on the lampshade. Apparently, the illuminating efficiency of these existing power saving illuminating devices using semiconductor luminotrons as electric light source is low and the illuminations are outdated and simplistic.

The object of the invention is to provide an improved power saving illuminating device using semiconductor luminotrons as electric light source which has a high illuminating efficiency and novel illuminations.

The present invention is realized by a power saving illuminating device comprising a base with an opening on it, at least one semiconductor luminotron and a DC power source disposed within the base, and a transparent refractive body covered on the opening of the base, said semiconductor luminotron being connected to said power source, wherein said transparent refractive body is full of light reflecting granulae within its body and is positioned in a manner that an end surface thereof is facing the semiconductor luminotron to enable an incident light from the semiconductor luminotron to have a long propagation inside the transparent refractive body.

The transparent refractive body in accordance with the present invention is a transparent body on which reflection and/or refraction can be caused. The light-reflecting granulae can be metallic or nonmetallic and can be flat and thin pieces or of other shapes. The diameter of the granulae is preferably not bigger than 4 mm and the density of the granulae within the transparent refractive body may vary with the size of the granulae or the specific illuminating devices. The body can either be lampshade-like, ball-like or column-like with different external forms. A semiconductor luminotron and a DC power source are disposed within the base of an illuminating device and the base is covered by a transparent refractive body. The semiconductor luminotron and the transparent refractive body are positioned in a manner that an incident light from the semiconductor luminotron will have a long propagation inside the transparent refractive body.

In accordance with the present invention, since light-reflecting granulae are evenly distributed within a transparent refractive body and an incident light from a semiconductor luminotron enters into the transparent refractive body from where the incident light will have a long propagation, a light from the semiconductor luminotrons can be propagated within the transparent refractive body. When a light into the transparent refractive body reaches a light reflecting granula, it is reflected and/or refracted. Reflection and/or refraction are formed among the light reflecting granulae which make the transparent refractive body shining and eye-catching. If light-reflecting granulae with rainbow-colored surface is adopted or two semiconductor luminotrons with different illuminating colors are used, the transparent refractive body will present various colors. From a very small luminous point to a large illuminating body, the illuminating efficiency of a semiconductor luminotron is greatly improved. Therefore, the illuminating device may not only be used as signposts, guideposts, colored lights, decoration lights, but also illuminating sign plates. Since illumination of the device according to the present invention is realized by reflection and/or refraction of the lights in the transparent refractive body, it is not necessary to use many semiconductor luminotrons. Therefore, the illuminating device according to the present invention is really power saving and is useful as ever-bright illuminators.

Now the present invention will be described with reference to the accompanying drawings.

### BRIEF DESCRIPTION OF THE DRAWINGS

FIG. 1 is the cross section view of an embodiment of the present invention;

FIG. 2 is the cross section view of another embodiment of the present invention;

FIG. 3 is the cross section view of a further embodiment of the present invention.

### DETAILED DESCRIPTION OF THE ILLUSTRATED EMBODIMENTS

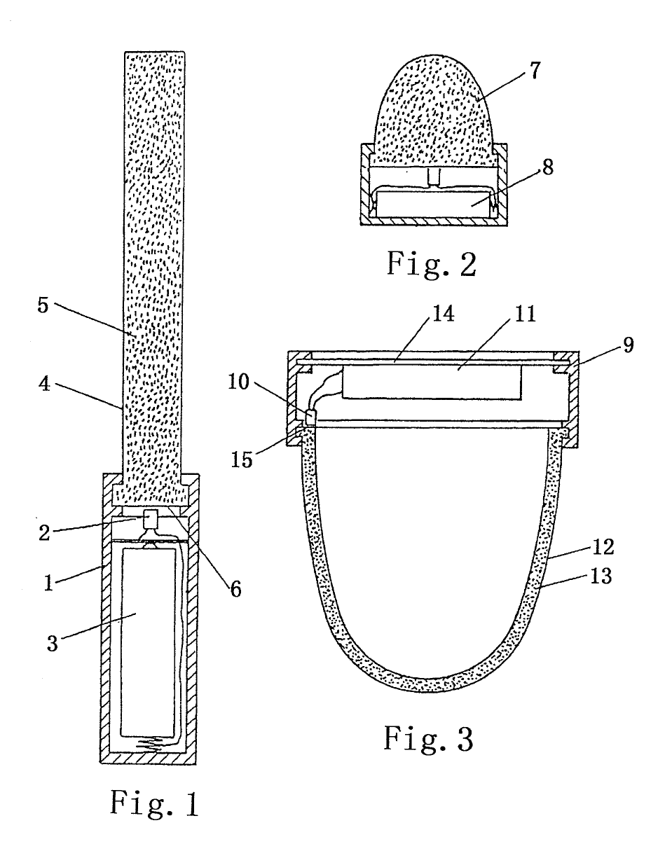

Refer to FIG. 1, the illuminating device comprises a base 1, a semiconductor luminotron 2, a DC power source 3, a transparent refractive body 4. Semiconductor luminotron 2 is disposed within base 1 with its positive and negative electrodes connected to the corresponding electrodes of the DC power source. Transparent refractive body 4 is a column-like body. Inside the body is full of light-reflecting granulae 5 which are evenly distributed. The diameter of the granulae 5 is not bigger than 4 mm. One end of the column-like body is mounted on the base with the outer surface of the body remaining outside base 1. Semiconductor luminotron 2 is positioned to face the end surface 6 of the column-like body. When power is on, semiconductor luminotron 2 illuminates and the light will be entering into the column-like body from end surface 6. Due to the reflection and/or refraction of the granulae 5, the column-like body will shine.

The structure of the device shown in FIG. 2 is similar to that of FIG. 1. The difference lies in the shape of transparent refractive body 4. In FIG. 2, transparent refractive body 4 is an egg-like solid body. A semiconductor luminotron 2 is positioned to face surface 6 of the body 4 so that light will enter into the egg-like solid body from surface 6.

In FIG. 3, transparent refractive body 4 is shaped like a lampshade. A semiconductor luminotron 2 and a DC power source 3 are disposed in base 1 which is covered by the lampshade. Semiconductor luminotron 2 is positioned to face the end surface 6 of the lampshade. Light from semiconductor luminotron 2 will enter into the lampshade from the end surface 6 and the lampshade will then shine. In order to make the lampshade have a well-distributed brightness, more than one semiconductor luminotron 2 can be evenly disposed along the end surface 6.

In the present invention, DC power source can be dry battery, storage battery, photocell or AC/DC converter. When a photocell pack is adopted, the photo sensor of the cell should be exposed to the outside of the base 1 so that the cell can be charged by ambient light.

The present invention has been described by referring to the accompanying drawings. However, it should be noted that the present invention is not limited to the embodiments described above. Any amendment without going beyond the spirit of the invention will fall into the scope of the invention.

I claim:

1. A power saving illuminating device comprising a base with an opening on it, at least one semiconductor luminotron and a DC power source disposed within the base, a transparent refractive body mounted on the opening of the base, said semiconductor luminotron being connected to said power source,
wherein said transparent refractive body is full of light-reflecting granula within its body and is positioned in a manner that an end surface thereof is facing the semiconductor luminotron to enable an incident light from the semiconductor luminotron to have a long propagation.

2. A power saving illuminating device according to claim 1, wherein said light-reflecting granula is evenly distributed within said transparent refractive body.

3. A power saving illuminating device according to claims 1 or 2, wherein light-reflecting granula has a diameter not more than 4 mm.

4. A power saving illuminating device according to claims 1, 2 or 3, wherein said light-reflecting granula is in the form of thin and flat pieces.

5. A power saving illuminating device according to claims 1, 2 or 3, wherein said light-reflecting granula is in the form of non-thin and flat pieces.

6. A power saving illuminating device according to claim 1, wherein said DC power source is a photocell.
